(19) United States
(12) Patent Application Publication
(10) Pub. No.: US 2017/0145915 A1
(43) Pub. Date: May 25, 2017

(54) SYSTEM AND METHOD FOR SUPPLYING AN ENERGY GRID WITH ENERGY FROM AN INTERMITTENT RENEWABLE ENERGY SOURCE

(71) Applicant: Siemens Aktiengesellschaft, Munich (DE)

(72) Inventors: Oliver Heid, Erlangen (DE); Paul Beasley, Abingdon, Oxfordshire (GB); Timothy Hughes, Wantage (GB)

(73) Assignee: Siemens Aktiengesellschaft, Munich (DE)

(21) Appl. No.: 15/315,499

(22) PCT Filed: Jun. 16, 2014
(86) PCT No.: PCT/EP2014/062581

§ 371 Date: Dec. 1, 2016

(51) Int. Cl. F02C 3/22; C01B 3/02; C25B 1/04; C01C 1/04; C01C 1/00; H02J 3/38; C01B 13/02

(52) U.S. Cl. CPC F02C 3/22; H02J 3/382; H02J 3/383; H02J 3/386; C01B 3/025; C01B 13/0207; C01C 1/04; C01C 1/003; C25B 1/04; F05D 2220/32; F05D 2210/12

(57) ABSTRACT

A system and method for supplying an energy grid with energy from an intermittent renewable energy source having a production unit for producing Hydrogen, Nitrogen, and Oxygen. The production unit is operated by using energy provided by the renewable energy source. An Oxygen storage receives and stores Oxygen produced by the production unit, a mixing unit receives and mixes the Hydrogen and the Nitrogen produced by the production unit to form a Hydrogen-Nitrogen-mixture, an Ammonia source receives and processes the Hydrogen-Nitrogen-mixture for generating a gas mixture containing Ammonia, an Ammonia power generator generates energy for the energy grid. The Ammonia power generator is fluidly connected to the Ammonia storage vessel, is configured to combust the received Ammonia in a combustion chamber to generate the energy, and is fluidly connected to the Oxygen storage to introduce Oxygen into the combustion chamber for combustion of Ammonia.

### CROSS REFERENCE TO RELATED APPLICATIONS

This application is the US National Stage of International Application No. PCT/EP2014/062581 filed Jun. 16, 2014, and claims the benefit thereof, and is incorporated by reference herein in its entirety.

### FIELD OF INVENTION

The invention relates to a system and method for supplying an energy grid with energy from an intermittent renewable energy source.

### BACKGROUND OF INVENTION

The uptake of renewable natural resources (renewables) for energy generation in the last years has been impressive, but there is still the unsolved problem of dealing with the transient nature of the renewables. Both solar and wind power are intermittent by their nature and, therefore, it is not possible to provide a dependable baseload to the energy networks. Since the demand of energy consumers can be irregular, a power supply based on renewables does not match the demand of the consumers. Also, the excess energy, i.e. the amount of energy which would be momentarily available from renewables but which is not demanded by the consumers at that time, strains the energy networks and would get lost in case it is not consumed.

Thus, conditions exist in which the energy momentarily provided by renewables is not sufficient to cover the demand. However, there would also be conditions in which the energy momentarily provided by renewables is exceeding the current demand. As the proportion of energy from renewable sources increases, the situation will become unsustainable.

A promising approach for solving these drawbacks would be the use of long term energy buffers or storages which are suitable to store the energy. Such a solution would allow to handle situations in which the demand exceeds the available energy as well as situations in which excess energy is available.

A variety of buffering solutions for storing electrical energy are known, e.g. Lithium batteries and Vanadium based Redox batteries, but these solutions cannot provide the necessary scale of energy storage. Hydrogen offers another carbon free route for storing energy, but it is difficult and risky to utilize. In gaseous form it has to be compressed to 500 bars in order to achieve a suitable energy density. Liquid Hydrogen requires cryogenic temperatures and the associated complicated infrastructure. Moreover, the use of Hydrogen in either form requires safeguards due to the risk of explosion. For these reasons, Hydrogen is not considered to be a qualified candidate for energy storage.

Thus, there are currently no reliable and appropriate means for decoupling energy supply and demands for renewable energies on a local or national scale.

### SUMMARY OF INVENTION

It is an object of the invention to provide a solution for supplying an energy grid with energy from an intermittent renewable energy source.

The object is solved by a system and a method according to the independent claims.

The invention is based on the approach of storing at least parts of the energy generated using renewable. This is achieved by using that energy to produce Hydrogen and Nitrogen. Hydrogen and Nitrogen are subsequently converted into Ammonia (NH3) which is a carbon-free fuel and which can be stored at ambient temperatures. Also, NH3 can be transported effectively and safely using pipelines, railroads, shipping and trucks. Moreover, NH3 offers the advantages that it can be synthesized in a carbon free process and it can be burned without generating green house gases.

The invention achieves a decoupling of the supply and demand of electricity from fluctuating renewable energy sources by using the renewable energy for the generation of Ammonia which can be stored subsequently. The stored Ammonia can then be used in a NH3 power generator to generate electricity which is fed into the electricity grid. This integrated solution proposed by the invention allows to translate intermittent electricity into a baseload provided by the renewable energy source to the local or national energy grid.

Moreover, the present invention also makes use of the Oxygen which is generated as a byproduct during the production of Hydrogen and/or Nitrogen. The Oxygen generated therein is directed to an Oxygen storage. The Oxygen storage is fluidly connected to the NH3 power generator such that Oxygen can be provided to the NH3 power generator to achieve an optimized performance of the NH3 power generator. For example, an increased Oxygen concentration during combustion will increase the efficiency and cleanliness of the NH3 burning.

The flow of Oxygen from the Oxygen storage to the NH3 power generator will be managed by a corresponding Oxygen control system. The Oxygen control system receives as an input the amount of NH3 reaching the NH3 power generator, i.e. the NH3 flow rate to the NH3 power generator, as well as combustion parameters which give information about the combustion status. For example, this might be the temperature in the combustion chamber and the chemical composition of the gas in the combustion chamber. Out of these data, the Oxygen control system determines the optimum flow rate of Oxygen to be provided from the Oxygen storage to the NH3 power generator.

Thus, the presence of the NH3 storage vessel as a buffer allows a better flexibility of providing energy to the energy grid and, therefore, an improved load balancing. Moreover, the efficiency of the system and method is improved by the usage of Oxygen produced in the system.

The invention can be applied for operating the energy network based on renewable energies as well as in the local energy supply for heavy industry and rural areas, grid stabilization.

In more detail, the system for providing energy for an energy grid and for load balancing of an energy input for the energy grid based on intermittent renewable energy provided by a renewable energy source, comprises—an H2-N2-O2-production unit for producing Hydrogen H2, Nitrogen N2 and Oxygen O2, wherein the H2-N2-O2-production unit is operated by using energy provided by the renewable energy source,—an Oxygen storage configured to receive and store the Oxygen produced by the H2-N2-O2-production unit,—a mixing unit configured to receive and mix the Hydrogen and the Nitrogen produced by the H2-N2-O2-production unit to form a Hydrogen-Nitrogen-mixture,—an NH3 source for receiving and processing the Hydrogen-Nitrogen-mixture for generating a gas mixture containing NH3, wherein the NH3 source is fluidly connected to the mixing unit to receive the Hydrogen-Nitrogen mixture from the mixing unit and wherein the NH3 source is configured to generate the gas mixture containing NH3 from the Hydrogen-Nitrogen-mixture, wherein the NH3 source comprises a NH3 storage vessel for storing at least a part of the NH3 of the gas mixture containing NH3,—an NH3 power generator for generating energy for the energy grid, wherein the NH3 power generator—is fluidly connected to the NH3 storage vessel to receive NH3 from the NH3 storage vessel,—is configured to combust the received NH3 in a combustion chamber to generate the energy for the energy grid,—is fluidly connected to the Oxygen storage such that Oxygen from the Oxygen storage can be introduced into the combustion chamber for the combustion of NH3 to increase the efficiency and cleanliness of the burning.

The system might comprise an Oxygen control system for controlling a flow of Oxygen from the Oxygen storage to the NH3 power generator based on an input data set which contains information about actual working conditions in the combustion chamber.

The working conditions might include at least one of—a status of combustion in the combustion chamber,—a flow rate of NH3 from the NH3 storage vessel to the NH3 power generator,—a temperature in the combustion chamber,—an actual chemical composition of a gas mixture in the combustion chamber, and/or—an actual chemical composition of combustion exhaust gases of the NH3 power generator.

This allows to operate the system with optimal parameters and efficiency.

The system might comprise a main control unit for controlling the generation of the NH3 to be stored in the NH3 storage vessel and/or controlling the generation of energy with the NH3 power generator. For example, the controlling can be achieved by regulating the energy flow provided to the H2-N2-production unit and, therewith, the production of H2 and N2 or by regulating the mass flow in the system via influencing mixers, compressors or other components and/or by regulating the temperature in NH3 reaction chamber.

The main control unit might be configured and arranged, i.e. connected to corresponding components, such that the controlling of the generation of the NH3 to be stored in the NH3 storage vessel and/or the controlling of the generation of energy with the NH3 power generator at least depends on an actual power demand in the energy grid and/or on an amount of energy currently generated by the renewable energy source. This allows a flexible energy supply which reacts to actual demands in the energy grid and which on the other hand allows to store energy form the renewable energy source in case of low demands.

The main control unit might be configured—to preferably simultaneously reduce the generation of the NH3 to be stored in the NH3 storage vessel, which can be achieved by controlling the generation of the gas mixture containing NH3, and/or increase the generation of energy during periods of low renewable energy input from the renewable energy source,—to preferably simultaneously increase the generation of the NH3 to be stored in the NH3 storage vessel and/or reduce the generation of energy during periods of high renewable energy input from the renewable energy source.

This also allows effective load balancing of an energy input for the energy grid and a flexible energy supply which reacts to actual demands in the energy grid and which on the other hand allows to store energy form the renewable energy source in case of low demands.

Therein, the terms “low” and “high” can be referenced to certain given threshold values. I.e. a low renewable energy input means that the actual renewable energy input is less than a first threshold and a high renewable energy input means that the actual renewable energy input is more than a second threshold. First and second threshold can be identical or different from each other.

The H2-N2-O2-production unit might comprise—an electrolyzer for producing the Hydrogen and Oxygen, wherein the electrolyzer is configured to receive water and energy produced by the renewable energy source and to produce the Hydrogen and the Oxygen by electrolysis, and—an air separation unit for producing the Nitrogen and Oxygen, wherein the air separation unit is configured to receive air and energy produced by the renewable energy source and to produce the Nitrogen and Oxygen by separating the received air. This allows to produce Hydrogen H2, Nitrogen N2, and Oxygen O2 by utilizing energy from the renewable energy source.

The mixing unit might be fluidly connected to the H2-N2-production unit to receive the Hydrogen and Nitrogen produced therein, wherein the mixing unit might comprise a mixer for mixing the Hydrogen with the Nitrogen to form a Hydrogen-Nitrogen-mixture and a compressor for compressing the Hydrogen-Nitrogen-mixture from the mixer to form a compressed Hydrogen-Nitrogen-mixture to be directed to the NH3 source. Thus, the mixing unit provides a compressed H2-N2-mixture.

The mixing unit might further comprises a temporary storage system for buffering the Hydrogen and the Nitrogen from the H2-N2-production unit, wherein the temporary storage system is configured to receive the Hydrogen and the Nitrogen from the H2-N2-production unit, to temporary store the Hydrogen and the Nitrogen for buffering and to subsequently process the buffered Hydrogen and Nitrogen to the mixer. This allows a more efficient mixing process.

The NH3 source might comprise—an NH3 reaction chamber configured to receive the Hydrogen-Nitrogen-mixture from the mixing unit and to process the received Hydrogen-Nitrogen-mixture to form the gas mixture containing NH3 and—a separator for receiving the gas mixture containing NH3 from the NH3 reaction chamber, wherein—the separator is configured to separate NH3 from the gas mixture containing NH3 such that NH3 and a remaining Hydrogen-Nitrogen-mixture are produced and—the separator is fluidly connected to the NH3 storage vessel to direct the produced NH3 to the NH3 storage vessel.

The usage of the separator allows an efficient production of NH3.

In one embodiment, an additional a re-processing unit for re-processing the remaining Hydrogen-Nitrogen-mixture with a re-compressor and a second mixer is available, wherein—the re-compressor is fluidly connected to the separator to receive and compress the remaining Hydrogen-Nitrogen-mixture from the separator,—the second mixer is fluidly connected to the re-compressor to receive the compressed remaining Hydrogen-Nitrogen-mixture from the re-compressor,—the second mixer is fluidly connected to the mixing unit to receive the Hydrogen-Nitrogen-mixture from the mixing unit, and wherein—the second mixer is configured to mix the Hydrogen-Nitrogen-mixture from the mixing unit and the compressed remaining Hydrogen-Nitrogen-mixture from the re-compressor to form the Hydrogen-Nitrogen mixture to be provided to the NH3 source. The use of the re-processing unit allows to re-cycle remaining H2 and N2 to form further NH3.

In an alternative embodiment, the separator might be fluidly connected to the mixing unit to direct the remaining Hydrogen-Nitrogen-mixture from the separator to the mixing unit, such that the remaining Hydrogen-Nitrogen-mixture is mixed in the mixing unit with the Hydrogen and the Nitrogen from the H2-N2-production unit to form the Hydrogen-Nitrogen-mixture to be received by the NH3 source. This also allows to re-cycle remaining H2 and N2 to form further NH3.

The system might further comprise an energy distribution unit which is configured to receive the energy provided by the renewable energy source and to distribute the energy to the energy grid and/or to the H2-N2-production unit, wherein the distribution depends on an energy demand situation in the energy grid. For example, in case of a higher energy demand from the energy grid, the fraction of energy provided by the renewable energy source to the energy grid is higher and the remaining fraction which is provided to the system is lower.

In case of a lower energy demand from the energy grid, the fraction of energy provided by the renewable energy source to the energy grid is lower and the remaining fraction which is provided to the system is higher. This allows an effective operation of the system and, in the consequence, load balancing of an energy input for the energy grid.

In a corresponding method for providing energy for an energy grid and for load balancing of an energy input for the energy grid based on intermittent renewable energy provided by a renewable energy source,—at least a part of the energy from the renewable energy source is used to produce Hydrogen, Nitrogen and Oxygen in a H2-N2-O2-production unit,—the produced Oxygen is directed to and stored in an Oxygen storage,—the produced Hydrogen and Nitrogen are mixed in a mixing unit to form a Hydrogen-Nitrogen-mixture,—the Hydrogen-Nitrogen-mixture is processed in a NH3 source to generate a gas mixture containing NH3 and NH3 of the gas mixture containing NH3 is stored in a NH3 storage vessel,—NH3 is provided from the NH3 storage vessel to a combustion chamber of a NH3 power generator and the provided NH3 is combusted in the combustion chamber for generating the energy for the energy grid, wherein—Oxygen from the Oxygen storage is introduced into the combustion chamber for the combustion of NH3 to increase the efficiency and cleanliness of the burning.

An Oxygen control system might control a flow of Oxygen from the Oxygen storage to the NH3 power generator based on an input data set which contains information about actual working conditions in the combustion chamber. This allows to operate the system at an optimal parameter set and correspondingly high efficiency.

Therein, the working conditions might include at least one of—a status of combustion in the combustion chamber,—a flow rate of NH3 from the NH3 storage vessel to the NH3 power generator,—a temperature in the combustion chamber, and/or—an actual chemical composition of a gas mixture in the combustion chamber,—an actual chemical composition of combustion exhaust gases of the NH3 power generator.

A main control unit of the system might control the generation of the NH3 to be stored in the NH3 storage vessel and/or the generation of energy with the NH3 power generator.

The gas mixture containing NH3 might be directed to a separator which separates NH3 from the gas mixture containing NH3 such that the NH3 to be stored in the NH3 storage vessel and a remaining Hydrogen-Nitrogen-mixture are produced. Thus, NH3 without further impurifications can be directed to the storage vessel.

In one embodiment, the remaining Hydrogen-Nitrogen-mixture is re-compressed and the re-compressed remaining Hydrogen-Nitrogen-mixture is mixed with the Hydrogen-Nitrogen-mixture from the mixing unit to form the Hydrogen-Nitrogen-mixture to be received by the NH3 source. Thus, Hydrogen and Nitrogen can be re-cycled to form further NH3.

In an alternative embodiment, the remaining Hydrogen-Nitrogen-mixture is mixed in the mixing unit with the Hydrogen and the Nitrogen from the H2-N2-O2-production unit to form the Hydrogen-Nitrogen-mixture to be received by the NH3 source. Thus, Hydrogen and Nitrogen can be re-cycled to form further NH3.

The main control unit might control the generation of the NH3 to be stored in the NH3 storage vessel and/or the generation of energy with the NH3 power generator at least depending on an actual power demand in the energy grid and/or on an amount of energy currently generated by the renewable energy source.

Moreover, the main control unit might—preferably simultaneously reduce the generation of the NH3 to be stored in the NH3 storage vessel (can be achieved by . . . ) and/or increases the generation of energy during periods of low renewable energy input from the renewable energy source,—preferably simultaneously increase the generation of the NH3 to be stored in the NH3 storage vessel and/or reduces the generation of energy during periods of high renewable energy input from the renewable energy source.

Thus, the main control unit controls the generation of NH3 and the generation of energy. For example, during periods in which the renewable energy source generates less energy, for example and in the case of a windmill during phases of low wind, the main control unit would power up the NH3 power generator to supply more energy into the energy grid because the supply by the renewable energy source might not be sufficient. During periods of in which the renewable energy source generates a high amount of energy, for example during phases with strong wind, the main control unit would power down the NH3 power generator because the renewable energy source provides sufficient energy to the grid. However, the main control unit would increase the production and storage of NH3.

A device being “fluidly connected” to a further device means that a fluid can be transferred via a connection between the devices, e.g. a tube, from the device to the further device. Therein, a fluid can be gaseous as well as liquid.

### BRIEF DESCRIPTION OF THE DRAWINGS

In the following, the invention is explained in detail on the basis of FIG. 1. Like reference numerals in different figures refer to the same components.

FIG. 1 shows a system for load balancing of an intermittent renewable energy source,

FIG. 2 shows a further embodiment of the system with a re-cycling of a remaining H2-N2-gas mixture,

FIG. 3 shows a variation of the further embodiment of the system.

### DETAILED DESCRIPTION OF INVENTION

The system 100 comprises a renewable energy source 10, for example a windmill or a windfarm with a plurality of individual windmills. Alternatively, the renewable energy source 10 can also be a solar power plant or any other power plant which is suitable for generating energy out of a renewable feedstock like water, wind, or solar energy. In the following, the system 100 is explained under the assumption that the renewable energy source 10 is a windmill. However, this should not have any limiting effect on the invention.

The windmill 10 is connected to an energy grid 300 to supply energy generated by the windmill 10 to the grid 300. Therein, an energy amount 1″ which is at least a fraction of the energy 1 generated by the windmill 10 is provided to the energy grid 300 to meet the energy demands of the consumers in the energy grid 300. It might be mentioned that the energy grid 300 would normally also have access to other energy sources.

However, a remaining energy amount 1′ of the generated energy 1 can be used in the system 100 to operate an Hydrogen-Nitrogen-Oxygen-production unit 20 (H2-N2-O2-production unit) of the system 100.

Especially when excess energy is available, i.e. when the energy 1 generated by the renewable energy source 10 is exceeding the energy demand of the energy grid 300 to the renewable energy source 10, this excess energy can be directed to the H2-N2-O2-production unit 20 to operate the unit 20. The amount of energy 1′ which is fed to the H2-N2-O2-production unit 20 depends on the energy demands of consumers to be supplied by the energy grid 300. I.e. in case of high demands, e.g. during peak times, it might be necessary that 100% of the energy 1 generated by the windmill 10 has to be fed into the electricity grid 300 to cover the demand. In contrast, in case of very low demands, e.g. during night times, 100% of the electricity 1 generated by the windmill 10 might be available for use in the system 100 and can be directed to the H2-N2-O2-production unit 20.

Such managing and distribution of energy 1 from the windmill 10 is achieved by an energy distribution unit 11. The energy distribution unit 11 receives the energy 1 from the windmill 10. As indicated above, certain ratios of the energy 1 are directed to the energy grid 300 and/or to the system 100 and the H2-N2-O2-production unit 20, respectively, depending on the energy demand situation in the energy grid 300. Thus, the energy distribution unit 11 is configured to receive the energy 1 provided by the renewable energy source 10 and to distribute the energy 1 to the energy grid 300 and/or to the H2-N2-O2-production unit 20, wherein the distribution depends on an energy demand situation in the energy grid 300.

For example, in case a high amount of energy is demanded in the grid 300, most or all of the energy 1 would be directed to the grid 300 and only less energy 1′ would be provided to the H2-N2-O2-production unit 20. In case the demand situation is such that only less energy is demanded in the grid 300, most or all of the energy 1 provided by the renewable energy source 10 can be used for generation of NH3. Thus, a high amount of energy 1′ would be provided to the H2-N2-O2-production unit 20.

As mentioned above, the amount 1′ of the energy 1 generated by the renewable energy source 10 is supplied to the system 100 and to the H2-N2-O2-production unit 20 to achieve the production of NH3. The H2-N2-O2-production unit 20 comprises an electrolyzer 21 and an air separation unit 22.

The electrolyzer 21 is used to generate Hydrogen 4 and Oxygen 6 through the electrolysis of water 2. The electrolyzer 21 is supplied with water 2 from an arbitrary source (not shown) and it is operated using the energy 1′ from the windmill 10.

The air separation unit (ASU) 22 of the H2-N2-O2-production unit 20 is used for the generation of Nitrogen 5 and Oxygen 7. Energy 1′ is used to operate the ASU 22 which utilizes conventional air separation techniques to separate Nitrogen 5 and Oxygen 7 from air 3. The remaining components of the air 3 can be released into the ambient air (not shown).

Thus, the windmill 10 is utilized to provide the energy 1′ for both the electrolysis of water 2 to form Hydrogen 4 and Oxygen 6 with the electrolyzer 21 and for separating Nitrogen 5 and Oxygen 7 from air 3 using the ASU 22.

Oxygen 6 from the Electrolyzer 21 and Oxygen 7 from the ASU 22 are directed to and subsequently stored in an Oxygen storage 70 of the system 100 whereas both Hydrogen 4 and Nitrogen 5 are directed to a mixing unit 30 of the system 100. Therein, established techniques are applied for separating Hydrogen from Oxygen and Nitrogen from Oxygen, respectively, which will not have to be explained in detail.

The mixing unit 30 comprises a temporary storage unit 31, a mixer 32 and a compressor 33. First, Hydrogen 4 and Nitrogen 5 pass the temporary storage unit 31 before being mixed in the mixer 32. The resulting Hydrogen-Nitrogen-gas mixture 8 (H2-N2-gas mixture) is subsequently compressed to fifty or more atmospheres in the compressor 33.

Ammonia NH3 can now be formed by processing the compressed H2-N2-gas mixture 8 in the presence of a catalyst at an elevated temperature. This is achieved in a NH3 reaction chamber 41 of a NH3 source 40 of the system 100. The compressed H2-N2-gas mixture 8 from the mixing unit 30 and from the compressor 33, respectively, is directed to the NH3 reaction chamber 41. The reaction chamber 41 comprises one or more NH3 reaction beds 42 which are operated at an elevated temperature of, for example, 350-450° C. The NH3 reaction chamber 41 produces a mixture of NH3 and, additionally, Nitrogen N2 and Hydrogen H2 out of the H2-N2-gas mixture from the mixer 30, i.e. the NH3 reaction chamber releases an NH3-H2-N2-gas mixture 9.

For example, a suitable catalyst can be based on iron promoted with K2O, CaO, SiO2, and Al2O3 or, rather than the iron based catalyst, ruthenium.

The NH3-H2-N2-mixture 9 is directed to a separator 43 of the NH3 source 40, for example a condenser, where NH3 is separated from the NH3-H2-N2-mixture 9. Thus, the separator 43 produces NH3, which is sent to an NH3 storage vessel 44 of the NH3 source 40, and a remaining H2-N2-gas mixture 8′.

It can be assumed that an extensive knowledge base exists both on the storage and on the transportation of Ammonia. The same is applicable for the handling and transportation of Hydrogen, Nitrogen, Hydrogen-Nitrogen-mixtures, and Oxygen. Therefore, the NH3 storage vessel 44, the Oxygen storage 70 as well as the variety of ducts which connect all the components of the system 100 for directing NH3 and other gases or gas mixtures are not described in detail.

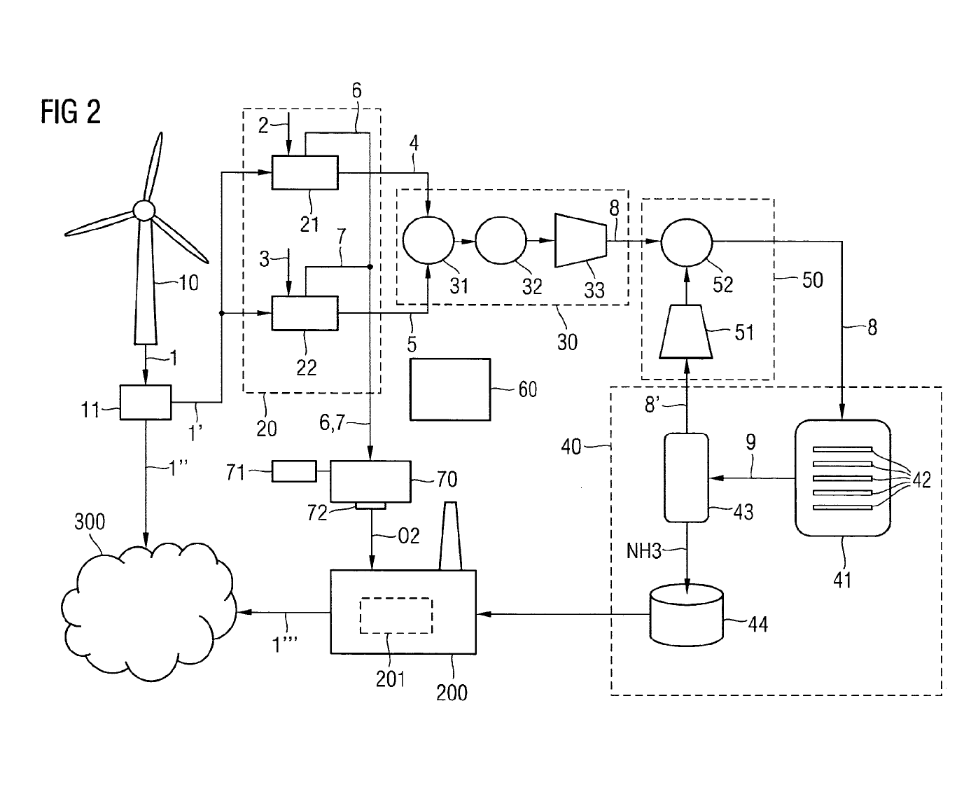

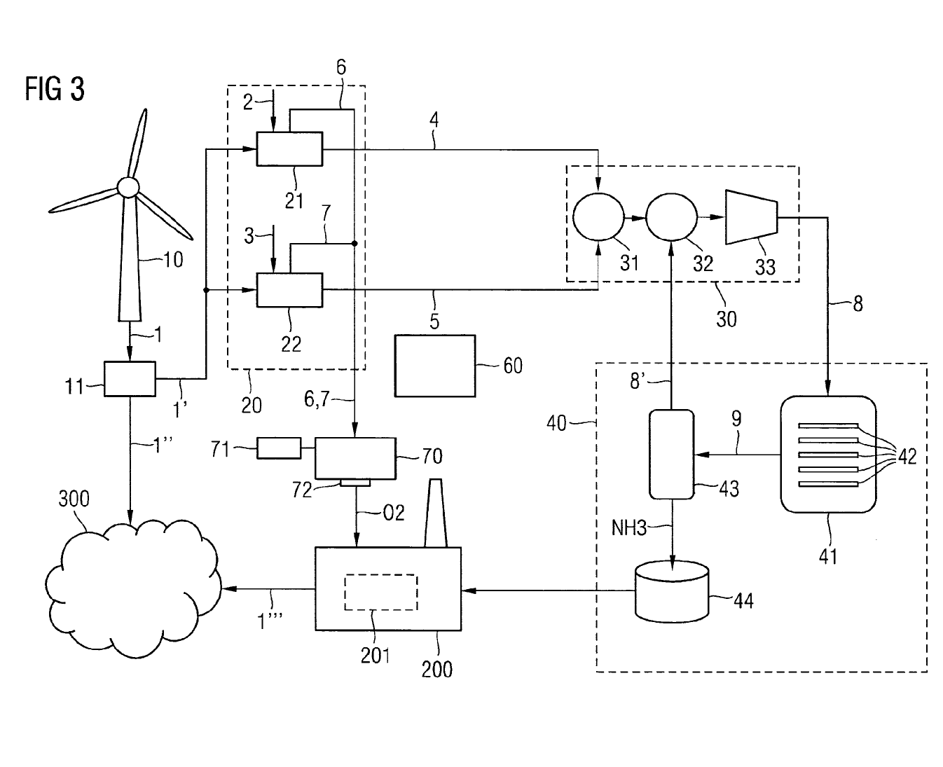

As explained above, the separator 43 generates NH3 out of the NH3-H2-N2-mixture 9 provided by the NH3 reaction chamber 41 and a H2-N2-gas mixture 8′ remains. In one embodiment of the invention, for which two variations are shown in FIGS. 2 and 3, this remaining H2-N2-gas mixture 8′ is re-cycled to be utilized again for the generation of NH3 in the NH3 reaction chamber 41.

For this, the system 100 of this embodiment as shown in FIG. 2 comprises an additional re-processing unit 50 with a re-compressor 51 and a mixer 52. Moreover, this embodiment of the invention differs from the above described basic embodiment of the invention in that the compressed H2-N2-gas mixture 8 from the compressor 33 is not passed directly to the NH3 reaction chamber 41, but it reaches the NH3 reaction chamber 41 only via the mixer 52 of the re-processing unit 50. The remaining H2-N2-gas mixture 8′ of the separator 43 is passed to the re-compressor 51 of the re-processing unit 50 of the system 100. Like the compressor 33, the re-compressor 51 compresses the remaining H2-N2-gas mixture 8′ to fifty or more atmospheres to account for pressure losses during the processing in the NH3 reaction chamber 41 and in the separator 43. The re-compressed remaining H2-N2-gas mixture 8′ is then passed to the mixer 52 where it is mixed with the fresh H2-N2-gas mixture 8 from the mixer 30 and the compressor 33, respectively. The mixer 52 generates a mixture 8 of the H2-N2-gas mixtures 8, 8′ which is subsequently directed to the NH3 reaction chamber 41. In the following, the gas mixture is processed as described above in the NH3 source 40 to produce NH3 and, again, a remaining H2-N2-gas mixture 8′.

FIG. 3 shows a variation of the embodiment shown in FIG. 2. The remaining H2-N2-gas mixture 8′ is directly fed into the mixer 32 of the mixing unit 30 to be mixed with the incoming Hydrogen and Nitrogen from the temporary storage unit 31. A separate re-processing unit 50 is not used.

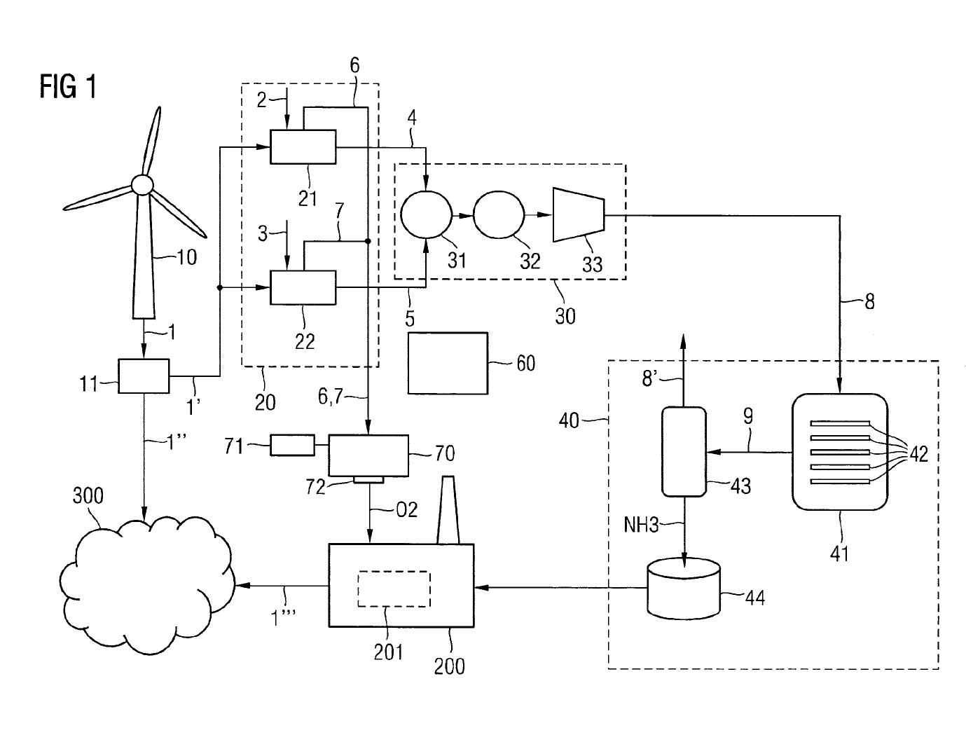

In the following, reference is made again to FIG. 1. However, the details and features described below are also applicable for the embodiments and variations shown in FIGS. 2 and 3.

The NH3 storage vessel 44 is fluidly connected with an NH3 power generator 200. Ammonia can be used in a number of different combustion cycles, for example in the Brayton cycle or in the Diesel cycle. However, at a power level of a windmill or a windfarm, it would be appropriate to use a gas turbine for combustion of Ammonia for the generation of electrical energy, wherein the Brayton cycle would be applicable for a gas turbine solution. Thus, the NH3 power generator 200 can be a gas turbine which is configured for the combustion of Ammonia. It has been shown earlier that conventional gas turbines with only slight modifications of the burner would be suitable.

The gas turbine 200 combusts the NH3 from the NH3 storage vessel 44 for the generation of energy 1′″ in a combustion chamber 201 of the NH3 power generator 200 and the gas turbine, respectively. This energy 1′″ can then be fed into the energy grid 300.

However, the performance and efficiency of the NH3 power generator 200 and the gas turbine, respectively, can be optimized by introducing additional Oxygen to the combustion process. For example, an increased Oxygen concentration during combustion will increase the efficiency and cleanliness of the NH3 burning. This can be achieved by making use of the Oxygen 6, 7 which is generated as described above as a byproduct during the production of Hydrogen 4 and/or Nitrogen 5 with the H2-N2-O2-production unit 20. As shown above, the generated Oxygen 6, 7 is directed to the Oxygen storage 70. The Oxygen storage 70 is fluidly connected to the NH3 power generator 200 such that Oxygen O2 can be provided to the NH3 power generator 200 to achieve an optimized performance.

The flow of Oxygen O2 from the Oxygen storage 70 to the NH3 power generator 200 is managed by a corresponding Oxygen control system 71. The Oxygen control system 71 receives (not shown) as an input a data set which contains information about actual working conditions of the NH3 power generator 200. These working conditions may include a status of combustion in the combustion chamber 201 of the NH3 power generator 200 and/or the amount of NH3 reaching the NH3 power generator 200 from the NH3 storage vessel 44, i.e. the NH3 flow rate to the NH3 power generator. Moreover, other combustion parameters which allow conclusions about working conditions in the NH3 power generator 200 can also be included in the data set, for example a temperature and/or an actual chemical composition of the gas in the combustion chamber 201 and/or an actual chemical composition of combustion exhaust gases of the NH3 power generator 200 and the combustion chamber 201, respectively. Out of these and potentially other data, the Oxygen control system 71 determines and regulates the optimum flow rate of Oxygen O2 to be provided from the Oxygen storage 70 to the NH3 power generator 200 and to the combustion chamber 201, respectively. For example, the data might be determined with corresponding sensors (not shown) and sensor data might be transferred to the Oxygen control system 71 wirelessly. Based on the data set, the Oxygen control system 71 controls a plurality of devices 72 like pumps, valves and/or other devices necessary for controlling a flow rate to influence the Oxygen O2 flow rate from the Oxygen storage 70 to the NH3 power generator 200.

The system 100 moreover comprises a main control unit 60 which is configured to control various components of the system 100 (connections of the main control unit 60 with other components of the system 100 are not shown in FIG. 1 to avoid confusion). Especially, the main control unit 60 controls the process of generating energy 1′″ for the energy grid 300 and the production of NH3.

In case the energy supply from the windmill 10 and the energy managing unit 11, respectively, to the system 100 is too low, for example due to high energy demands in the energy grid 300, the main control unit 60 reduces the production of NH3 by reducing the gas mass flow in the system 100 by powering down the compressors 33, 51 and/or the H2-N2-O2-production unit 20 with the electrolyzer 21 and the ASU 22. Thus, less energy 1′ is directed from the windmill 10 to the system 100 and more energy 1″ is available for the energy grid 300. Moreover, the main control unit 60 increases the NH3 mass flow from the NH3 storage vessel 44 to the NH3 power generator 200. Consequently, the NH3 power generator 200 increases the generation of energy 1′″ required for the energy grid 300 in order to guarantee a stable energy supply in the grid 300 to achieve a balanced load.

In case the energy supply from the windmill 10 and the electricity managing unit 11, respectively, to the system 100 is too high, for example when the windmill 10 generates more energy than required by the energy grid 300, the main control unit 60 intensifies the production of NH3 in the system 100 by increasing the gas mass flow in the system 100 by providing more power to the compressors 33, 51, to the electrolyzer 21 and/or to the ASU 22. This results in an increased production of NH3 which is stored in the NH3 storage vessel 44. However, the generation of energy 1′″ from the NH3 power generator 200 for the energy grid 300 is not increased, but it might be decreased.

Moreover, the main control unit 60 controls the generation of power in the NH3 power generator 200 based on the energy consumption and demand in the electricity grid 300 and based on the available power supply by any energy sources available for the grid 300. Thus, in case the available power supply in the grid 300 is less than the demand, the main control unit 60 would power up the NH3 power generator 200 to cover the demand. In case the available power supply in the grid 300 is higher than the demand, the main control unit 60 would power down the NH3 power generator 200 and the NH3 generation would be intensified by supplying more energy to the H2-N2-O2-production unit 20 and by increasing the mass flow in the system 100 so that the NH3 storage vessel 44 can be filled up again.

In other words, the main control unit 60 is configured to reduce the generation of NH3 to be directed to the NH3 storage vessel 44 and/or increase the generation of energy 1′″ during periods of too low renewable energy input 1, e.g. during periods of low wind and/or high energy demands in the energy grid 300. Also, the main control unit 60 is configured to increase the generation of NH3 to be directed to the NH3 storage vessel 44 and/or reduce the generation of energy 1′″ during periods of too high renewable energy input 1, e.g. during periods of strong winds and/or low energy demands in the grid 300.

Thus, the controlling performed by the main control unit 60 may depend on the actual power demand in the energy grid 300, the energy 1 generated by the renewable energy source 10, and/or the actual amount of energy 1′ from the renewable energy source 10 available for the system 100.

Correspondingly, the main control unit 60 has to be connected to the energy grid 300 to receive information about the current energy demand and coverage in the grid 300. Moreover, the main control unit 60 would be connected to the energy distribution unit 11 and/or to the windmill 10 directly to receive information about energy 1, 1′, 1″ provided by the windmill 10 and available for usage in the system 100 and in the grid 300. The main control unit 60 would have to be connected to the H2-N2-O2-production unit 20 to control the amount of produced Hydrogen and Nitrogen and to the various mixers and compressors, if applicable, to regulate the mass flow in the system. With this, the main control unit 60 can regulate the production of NH3 to be directed to the NH3 storage vessel 44. In addition to this, the main control unit 60 is connected to the NH3 storage vessel 44 to regulate the supply of NH3 to the NH3 power generator 200 and to the NH3 power generator 200 itself to regulate the energy generation by NH3 combustion. Finally, the main control unit 60 can be connected to the Oxygen control system 71 such that the Oxygen O2 flow rate from the Oxygen storage 70 to the NH3 power generator 200 can also be influenced centrally by the main control unit 60.

1. A system for providing energy for an energy grid based on energy provided by a renewable energy source, comprising
an H2-N2-O2-production unit for producing Hydrogen, Nitrogen, and Oxygen, wherein the H2-N2-O2-production unit is operated by using energy provided by the renewable energy source,
an Oxygen storage configured to receive and store the Oxygen produced by the H2-N2-O2-production unit,
a mixing unit configured to receive and mix the Hydrogen and the Nitrogen produced by the H2-N2-O2-production unit to form a Hydrogen-Nitrogen-mixture,
an NH3 source for receiving and processing the Hydrogen-Nitrogen-mixture for generating a gas mixture containing NH3, wherein the NH3 source comprises a NH3 storage vessel for storing at least a part of the NH3 of the gas mixture containing NH3,
an NH3 power generator for generating energy for the energy grid, wherein the NH3 power generator
is fluidly connected to the NH3 storage vessel to receive NH3 from the NH3 storage vessel,
is configured to combust the received NH3 in a combustion chamber to generate the energy for the energy grid,
is fluidly connected to the Oxygen storage such that Oxygen (O2) from the Oxygen storage can be introduced into the combustion chamber for the combustion of NH3.

2. The system according to claim 1, comprising
an Oxygen control system for controlling a flow of Oxygen (O2) from the Oxygen storage to the NH3 power generator based on an input data set which contains information about actual working conditions in the combustion chamber.

3. The system according to claim 2, wherein the working conditions include at least one of
a status of combustion in the combustion chamber,
a flow rate of NH3 from the NH3 storage vessel to the NH3 power generator,
a temperature in the combustion chamber,
an actual chemical composition of a gas mixture in the combustion chamber, and/or
an actual chemical composition of combustion exhaust gases of the NH3 power generator.

4. The system according to claim 1, comprising
a main control unit for controlling the generation of the NH3 to be stored in the NH3 storage vessel and/or the generation of energy with the NH3 power generator.

5. A system according to claim 4,
wherein the main control unit is configured and arranged such that the controlling of the generation of the NH3 to be stored in the NH3 storage vessel and/or of the generation of energy with the NH3 power generator depends on an actual power demand in the energy grid and/or on an amount of energy currently generated by the renewable energy source.

6. The system according to claim 4, wherein the main control unit is configured
to reduce the generation of the NH3 to be stored in the NH3 storage vessel and/or increase the generation of energy during periods of low renewable energy input from the renewable energy source,
to increase the generation of the NH3 to be stored in the NH3 storage vessel and/or reduce the generation of energy during periods of high renewable energy input from the renewable energy source.

7. The system according to claim 1, wherein the H2-N2-O2-production unit comprises
an electrolyzer for producing the Hydrogen and Oxygen, wherein the electrolyzer is configured to receive water and energy produced by the renewable energy source and to produce the Hydrogen and the Oxygen by electrolysis, and
an air separation unit for producing the Nitrogen and Oxygen, wherein the air separation unit is configured to receive air and energy produced by the renewable energy source and to produce the Nitrogen and Oxygen by separating the received air.

8. The system according to claim 1,
wherein the mixing unit is fluidly connected to the H2-N2-O2-production unit to receive the Hydrogen and Nitrogen produced therein, wherein the mixing unit comprises
a mixer for mixing Hydrogen with Nitrogen to form a Hydrogen-Nitrogen-mixture and
a compressor for compressing the Hydrogen-Nitrogen-mixture from the mixer to form a compressed Hydrogen-Nitrogen-mixture to be directed to the NH3 source.

9. The system according to claim 1,
wherein the NH3 source comprises
an NH3 reaction chamber configured to receive the Hydrogen-Nitrogen-mixture from the mixing unit and to process the received Hydrogen-Nitrogen-mixture to form the gas mixture containing NH3, and
a separator for receiving the gas mixture containing NH3 from the NH3 reaction chamber,
wherein
the separator is configured to separate NH3 from the gas mixture containing NH3 such that NH3 and a remaining Hydrogen-Nitrogen-mixture are produced and
the separator is fluidly connected to the NH3 storage vessel to direct the produced NH3 to the NH3 storage vessel.

10. The system according to claim 9, further comprising
a re-processing unit for re-processing the remaining Hydrogen-Nitrogen-mixture with a re-compressor and a second mixer,
wherein the re-compressor is fluidly connected to the separator to receive and compress the remaining Hydrogen-Nitrogen-mixture from the separator,
wherein the second mixer is fluidly connected to the re-compressor to receive the compressed remaining Hydrogen-Nitrogen-mixture from the re-compressor,
wherein the second mixer is fluidly connected to the mixing unit to receive the Hydrogen-Nitrogen-mixture from the mixing unit, and
wherein the second mixer is configured to mix the Hydrogen-Nitrogen-mixture from the mixing unit and the compressed remaining Hydrogen-Nitrogen-mixture from the re-compressor to form the Hydrogen-Nitrogen mixture to be provided to the NH3 source.

11. The system according to claim 9,
wherein the separator is fluidly connected to the mixing unit to direct the remaining Hydrogen-Nitrogen-mixture from the separator to the mixing unit, such that the remaining Hydrogen-Nitrogen-mixture is mixed in the mixing unit with the Hydrogen and the Nitrogen from the H2-N2-O2-production unit to form the Hydrogen-Nitrogen-mixture to be received by the NH3 source.

12. The system according to claim 1, further comprising
an energy distribution unit which is configured to receive the energy provided by the renewable energy source and to distribute the energy to the energy grid and/or to the H2-N2-O2-production unit, wherein the distribution depends on an energy demand situation in the energy grid.

13. A method for load balancing of an energy input for an energy grid based on energy provided by a renewable energy source, the method comprising:
using at least a part of the energy from the renewable energy source to produce Hydrogen, Nitrogen and Oxygen in a H2-N2-O2-production unit,
directing to and storing the produced Oxygen in an Oxygen storage,
mixing the produced Hydrogen and Nitrogen in a mixing unit to form a Hydrogen-Nitrogen-mixture,
processing the Hydrogen-Nitrogen-mixture in a NH3 source to generate a gas mixture containing NH3 and storing NH3 of the gas mixture containing NH3 in a NH3 storage vessel,
providing NH3 from the NH3 storage vessel to a combustion chamber of a NH3 power generator and combusting the provided NH3 in the combustion chamber for generating the energy for the energy grid,
wherein
Oxygen (O2) from the Oxygen storage is introduced into the combustion chamber for the combustion of NH3.

14. The method according to claim 13,
wherein an Oxygen control system controls a flow of Oxygen (O2) from the Oxygen storage to the NH3 power generator based on an input data set which contains information about actual working conditions in the combustion chamber.

15. The method according to claim 14,
wherein the working conditions include at least one of
a status of combustion in the combustion chamber,
a flow rate of NH3 from the NH3 storage vessel to the NH3 power generator,
a temperature in the combustion chamber, and/or
an actual chemical composition of a gas mixture in the combustion chamber,
an actual chemical composition of combustion exhaust gases of the NH3 power generator.

16. The method according to claim 13,
wherein a main control unit of the system controls the generation of the NH3 to be stored in the NH3 storage vessel and/or the generation of energy with the NH3 power generator.

17. The method according to claim 16,
wherein the gas mixture containing NH3 is directed to a separator which separates NH3 from the gas mixture containing NH3 such that the NH3 to be stored in the NH3 storage vessel and a remaining Hydrogen-Nitrogen-mixture are produced.

18. The method according to claim 17,
wherein the remaining Hydrogen-Nitrogen-mixture is re-compressed and the re-compressed remaining Hydrogen-Nitrogen-mixture is mixed with the Hydrogen-Nitrogen-mixture from the mixing unit to form the Hydrogen-Nitrogen-mixture to be received by the NH3 source.

19. The method according to claim 17,
wherein the remaining Hydrogen-Nitrogen-mixture is mixed in the mixing unit with the Hydrogen and the Nitrogen from the H2-N2-O2-production unit to form the Hydrogen-Nitrogen-mixture to be received by the NH3 source.

20. The method according to claim 13,
wherein the main control unit controls the generation of the NH3 to be stored in the NH3 storage vessel and/or the generation of energy with the NH3 power generator at least depending on an actual power demand in the energy grid and/or on an amount of energy currently generated by the renewable energy source.

21. The method according to claim 13,
wherein the main control unit
reduces the generation of the NH3 to be stored in the NH3 storage vessel and/or increases the generation of energy during periods of low renewable energy input from the renewable energy source, and
increases the generation of the NH3 to be stored in the NH3 storage vessel and/or reduces the generation of energy during periods of high renewable energy input from the renewable energy source.
